(19) United States
(12) Patent Application Publication
(10) Pub. No.: US 2024/0248483 A1
(43) Pub. Date: Jul. 25, 2024

(54) INFORMATION PROCESSING DEVICE, MOVING BODY, INFORMATION PROCESSING METHOD, AND PROGRAM

(71) Applicant: TOHOKU UNIVERSITY, Sendai-shi, Miyagi (JP)

(72) Inventors: Kazunori OHNO, Sendai-shi (JP); Yoshito OKADA, Sendai-shi (JP); Shotaro KOJIMA, Sendai-shi (JP); Masashi KONYO, Sendai-shi (JP); Satoshi TADOKORO, Sendai-shi (JP); Kenta GUNJI, Sendai-shi (JP)

(21) Appl. No.: 18/561,611

(22) PCT Filed: Jun. 2, 2021
(86) PCT No.: PCT/JP2021/021001

§ 371 Date: Nov. 16, 2023

(51) Int. Cl. G05D 1/246; G06T 7/73

(52) U.S. Cl. CPC G05D 1/2462; G06T 7/73; G06T 2207/30204

(57) ABSTRACT

An information processing device for controlling a control target device to be controlled includes: a storage unit configured to store layout constraint condition information including information indicating relative positions of a first object disposed in a space in which the control target device is positioned and a second object different from the first object disposed in the space; and a control unit configured to generate map information indicating a map in the space based on a position of the control target device, at least one of first object-device relative position information indicating relative positions of the first object and the control target device or second object-device relative position information indicating relative positions of the second object and the control target device, and the layout constraint condition information stored in the storage unit.

### TECHNICAL FIELD

The present invention relates to an information processing device, a moving body, an information processing method, and a program.

### BACKGROUND ART

Research and development are being performed on an information processing device for controlling a device to be controlled, such as a robot or a drone.

In this regard, there has been an information processing device for controlling a robot, which detects relative positions and postures of an object and the robot in a space in which the robot is positioned, and generates map information indicating a map in the space based on the detected positions and postures (see NPL 1).

### CITATION LIST

### Non Patent Literature

[NPL 1] “Acquisition of Spatial Structure by Interaction with Environment”, Masahiro Tomono, JST Project Database, 2005 Final Annual Report, https://projectdb.jst.go.jp/report/JST-PROJECT-7700000694/2913/

### SUMMARY OF INVENTION

### Technical Problem

There also has been a method of detecting relative positions and postures of an object and a robot in a certain space, and generating map information indicating a map in the space based on the detected positions and postures and an initial arrangement of a plurality of objects positioned in the space. However, the arrangement of the plurality of objects in the space is often changed from the initial arrangement. In the method, however, when the initial arrangement of the plurality of objects positioned in the space is changed, map information indicating a map with poor accuracy may be generated.

The invention has been made in view of such circumstances, and an object thereof is to provide an information processing device, a moving body, an information processing method, and a program capable of accurately generating map information indicating a map in a space in which a control target device is positioned even when an arrangement of a plurality of objects in the space is changed from an initial arrangement.

### Solution to Problem

The invention includes the following aspects.

[1] An information processing device for controlling a control target device to be controlled includes: a storage unit configured to store layout constraint condition information including information indicating relative positions of a first object disposed in a space in which the control target device is positioned and a second object different from the first object disposed in the space; and a control unit configured to generate map information indicating a map in the space based on a position of the control target device, at least one of first object-device relative position information indicating relative positions of the first object and the control target device or second object-device relative position information indicating relative positions of the second object and the control target device, and the layout constraint condition information stored in the storage unit.

[2] In the information processing device described above, the control unit includes: a first estimation unit configured to estimate the position of the control target device based on a predetermined initial value; an acquisition unit configured to acquire at least one of the first object-device relative position information or the second object-device relative position information as object-device relative position information; and a generation unit configured to generate the map information indicating the map in the space based on the layout constraint condition information stored in the storage unit, the object-device relative position information acquired by the acquisition unit, and the position of the control target device estimated by the first estimation unit.

[3] In the information processing device described above, the control unit further includes a second estimation unit configured to estimate at least one of the relative positions of the first object and the control target device or the relative positions of the second object and the control target device based on an output from a detection unit that detects at least one of the first object or the second object, and the acquisition unit is configured to acquire, from the second estimation unit, information indicating at least one of the relative positions of the first object and the control target device or the relative positions of the second object and the control target device as the object-device relative position information.

[4] In the information processing device described above, the generation unit is configured to generate an information matrix and an information vector in graph-simultaneous localization and mapping (SLAM) based on the object-device relative position information acquired by the acquisition unit, layout the constraint condition information stored in the storage unit, and the position of the control target device estimated by the first estimation unit, and generate the map information by optimizing an evaluation function based on the generated information matrix and information vector.

[5] In the information processing device described above, the generation unit is configured to estimate positions of the first object and the second object based on the object-device relative position information acquired by the acquisition unit, the layout constraint condition information stored in the storage unit, and the position of the control target device estimated by the first estimation unit, and generate the information matrix and the information vector based on the estimated positions of the first object and the second object.

[6] In the information processing device described above, the generation unit is configured to: if both the first object-device relative position information and the second object-device relative position information are acquired by the acquisition unit as the object-device relative position information, estimate the position of the first object as a first estimated position and estimate the position of the second object as a second estimated position based on the position of the control target device estimated by the first estimation unit, the object-device relative position information acquired by the acquisition unit, and the layout constraint condition information stored in the storage unit; estimate the position of the first object as a third estimated position and estimate the position of the second object as a fourth estimated position based on the position of the control target device estimated by the first estimation unit and the object-device relative position information acquired by the acquisition unit; calculate a difference between a vector indicating the first estimated position and a vector indicating the third estimated position as a first difference and calculate a difference between a vector indicating the second estimated position and a vector indicating the fourth estimated position as a second difference; and delete connections between elements of the information matrix that are determined according to the layout constraint condition information, based on the first difference, an estimation error of the position of the first object, the second difference, and an estimation error of the position of the second object.

[7] In the information processing device described above, the control target device is a moving body configured to change at least one of the position or a posture of the control target device.

[8] A moving body includes the information processing device described above as the control target device.

[9] An information processing method includes: a reading step of reading layout constraint condition information including information indicating relative positions of a first object disposed in a space in which a control target device to be controlled is positioned and a second object different from the first object disposed in the space from a storage unit that stores the layout constraint condition information; and a generating step of generating map information indicating a map in the space based on a position of the control target device, at least one of first object-device relative position information indicating relative positions of the first object and the control target device or second object-device relative position information indicating relative positions of the second object and the control target device, and the layout constraint condition information read in the reading step.

[10] A program causes a computer to execute: a reading step of reading layout constraint condition information including information indicating relative positions of a first object disposed in a space in which a control target device to be controlled is positioned and a second object different from the first object disposed in the space from a storage unit that stores the layout constraint condition information; and a generating step of generating map information indicating a map in the space based on a position of the control target device, at least one of first object-device relative position information indicating relative positions of the first object and the control target device or second object-device relative position information indicating relative positions of the second object and the control target device, and the layout constraint condition information read in the reading step.

[11] An information processing device for controlling a control target device to be controlled includes: a storage unit configured to store layout constraint condition information including information indicating relative postures of a first object disposed in a space in which the control target device is positioned and a second object different from the first object disposed in the space; and a control unit configured to generate map information indicating a map in the space based on a posture of the control target device, at least one of first object-device relative posture information indicating relative postures of the first object and the control target device or second object-device relative posture information indicating relative postures of the second object and the control target device, and the layout constraint condition information stored in the storage unit.

[12] A moving body includes the information processing device described above as the control target device.

[13] An information processing method includes: a reading step of reading layout constraint condition information including information indicating relative postures of a first object disposed in a space in which a control target device to be controlled is positioned and a second object different from the first object disposed in the space from a storage unit that stores the layout constraint condition information; and a generating step of generating map information indicating a map in the space based on a posture of the control target device, at least one of first object-device relative posture information indicating relative postures of the first object and the control target device or second object-device relative posture information indicating relative postures of the second object and the control target device, and the layout constraint condition information read in the reading step.

[14] A program causes a computer to execute: a reading step of reading layout constraint condition information including information indicating relative postures of a first object disposed in a space in which a control target device to be controlled is positioned and a second object different from the first object disposed in the space from a storage unit that stores the layout constraint condition information; and a generating step of generating map information indicating a map in the space based on a posture of the control target device, at least one of first object-device relative posture information indicating relative postures of the first object and the control target device or second object-device relative posture information indicating relative postures of the second object and the control target device, and the layout constraint condition information read in the reading step.

### Advantageous Effects of Invention

According to the invention, even when an arrangement of a plurality of objects in a space in which a control target device is positioned is changed from an initial arrangement, map information indicating a map in the space can be accurately generated.

### BRIEF DESCRIPTION OF DRAWINGS

FIG. 1 is a diagram illustrating an example of a configuration of a control system 1 according to an embodiment.

FIG. 2 is a diagram illustrating an example of a hardware configuration of an information processing device 30.

FIG. 3 is a diagram illustrating an example of a functional configuration of the information processing device 30.

FIG. 4 is a conceptual diagram of a vector illustrated in Formula (4).

FIG. 5 is a diagram illustrating an example of a flow of processing of generating an information matrix Ω and an information vector ξ by the information processing device 30.

FIG. 6 is a diagram illustrating an example of a flow of processing of generating map information by the information processing device 30.

FIG. 7 is a diagram illustrating an example of the map information generated by the information processing device 30.

FIG. 8 is a diagram illustrating another example of the map information generated by the information processing device 30.

FIG. 9 is a diagram illustrating still another example of the map information generated by the information processing device 30.

FIG. 10 is a diagram illustrating yet another example of the map information generated by the information processing device 30.

FIG. 11 is a diagram illustrating another example of the configuration of the control system 1 according to the embodiment.

FIG. 12 is a diagram illustrating an example of an object M1 provided with three markers.

### DESCRIPTION OF EMBODIMENTS

### Embodiment

Hereinafter, an embodiment of the invention will be described with reference to the drawings.

### Configuration of Control System

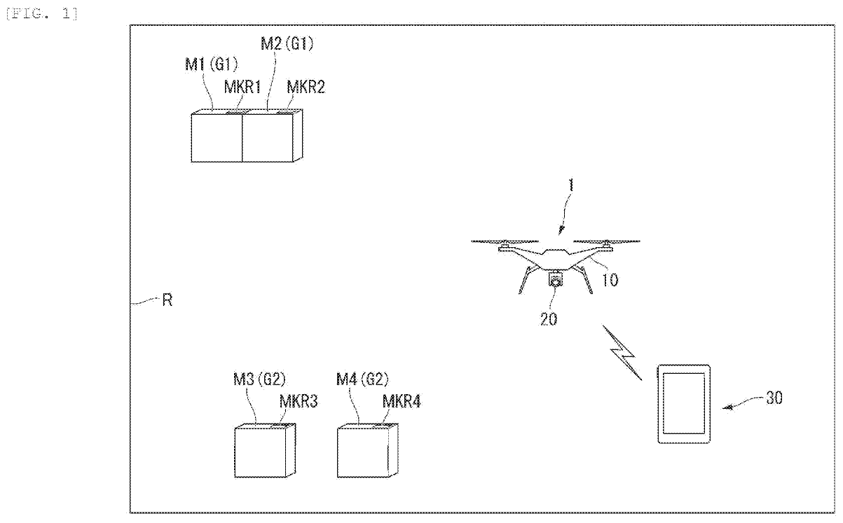

Hereinafter, a configuration of a control system 1 according to the embodiment will be described with reference to FIG. 1. FIG. 1 is a diagram illustrating an example of the configuration of the control system 1 according to the embodiment.

The control system 1 includes a control target device 10 to be controlled, a detection unit 20 provided in the control target device 10, and an information processing device 30. In the example illustrated in FIG. 1, in the control system 1, the control target device 10, the detection unit 20, and the information processing device 30 are separately configured. However, in the control system 1, a part or all of the control target device 10, the detection unit 20, and the information processing device 30 may be integrally configured. In addition, in the control system 1, if both the control target device 10 and the detection unit 20 are separated from the information processing device 30 as illustrated in FIG. 1, the information processing device 30 may be communicably connected to the control target device 10 and the detection unit 20 via a network such as a local area network (LAN), a wide area network (WAN), or a private communication network, or may be communicably connected to the control target device 10 and the detection unit 20 by wire or wirelessly. In the following, a case where the information processing device 30 is communicably connected to the control target device 10 and the detection unit 20 wirelessly will be described as an example.

The control system 1 generates map information indicating a map in a space in which the control target device 10 is positioned. In the following, for convenience of description, the space in which the control target device 10 is positioned will be referred to as a target space R. The target space R is, for example, a space in a room in which the control target device 10 is positioned, but is not limited thereto. A space that can be the target space R other than the space in the room in which the control target device 10 is positioned is, for example, water, air, outer space, or the like.

In the present embodiment, the target space R is a space in which a plurality of objects are arranged. At least a part of the plurality of objects arranged in the target space R are grouped into one or more groups according to uses thereof. The one or more groups are configured by grouping two or more objects. Therefore, the plurality of objects arranged in the target space R may include one or more objects that are not grouped as a group. In the following, as an example, a case where the plurality of objects arranged in the target space R are four objects M1 to M4 illustrated in FIG. 1 will be described. In addition, in the following, a case as illustrated in FIG. 1 where the object M1 and the object M2 are grouped into a group G1 and the object M3 and the object M4 are grouped into a group G2 will be described as an example. That is, in the example illustrated in FIG. 1, the four objects arranged in the target space R are grouped into two groups. Therefore, in the example, the four objects placed in the target space R do not include any ungrouped objects.

A reason why the four objects in the target space R are grouped into two groups is that relative positions and postures of the objects in each group are often held even when an arrangement of the four objects is changed to an arrangement different from an initial arrangement. For example, when the object M1 and the object M2 grouped into the group G1 are connected side by side in the target space R, even when the arrangement of the object M1 and the object M2 is changed to an arrangement different from the initial arrangement, the arrangement is changed to the arrangement different from the initial arrangement while the relative positions and postures of the object M1 and the object M2 are held unless the uses of the object M1 and the object M2 are changed. This is because a state in which the object M1 and the object M2 are connected side by side is a state suitable for the uses of the object M1 and the object M2. Examples of the object used in this manner include workbenches and shelves. Under such circumstances, it can be considered that the arrangement of the objects, that is, a layout of the objects, is constrained so as to be unchanged or substantially unchanged in each group. Therefore, in each group, the relative positions and postures of the objects can be used as a constraint condition that the arrangement of the objects is constrained so as not to change in the generation of the map information indicating the map in the target space R.

Therefore, the control system 1 generates the map information indicating the map in the target space R based on layout constraint condition information for each group in the target space R. That is, the control system 1 generates the map information based on the layout constraint condition information of the group G1 and the layout constraint condition information of the group G2. In the following, for convenience of description, the layout constraint condition information of the group G1 and the layout constraint condition information of the group G2 will be collectively referred to as layout constraint condition information unless necessary to be distinguished. In the following, for convenience of description, the constraint may be referred to as layout constraint. In the following, the constraint condition may be referred to as a layout constraint condition.

Here, the layout constraint condition information of a certain group in the target space R is information indicating a constraint condition for constraining so as not to change an arrangement of the two or more objects grouped in the target space. More specifically, the layout constraint condition information is information including information indicating relative positions and postures of the two or more objects grouped in the group as the constraint condition. That is, the layout constraint condition information of the group G1 in the target space R is information including information indicating the relative positions and postures of the object M1 and the object M2 as a constraint condition for constraining so as not to change the arrangement of the object M1 and the object M2. In the following, a case where the layout constraint condition information includes information indicating error values allowed for the relative positions and postures of the object M1 and the object M2 in addition to the information indicating the relative positions and postures of the object M1 and the object M2 will be described as an example. In addition, the layout constraint condition information of the group G2 in the target space R is information including information indicating the relative positions and postures of the object M3 and the object M4 as a constraint condition for constraining so as not to change the arrangement of the object M3 and the object M4. In the following, a case where the layout constraint condition information includes information indicating error values allowed for the relative positions and postures of the object M3 and the object M4 in addition to the information indicating the relative positions and postures of the object M3 and the object M4 will be described as an example.

By using such layout constraint condition information, even when the arrangement of the plurality of objects in the target space R is changed from the initial arrangement, the control system 1 can accurately generate the map information indicating the map in the target space R. This is because at least a part of the arrangement of the plurality of objects after being changed from the initial arrangement can be estimated based on the layout constraint condition information. In the following, a case where the control system 1 generates the map information indicating the map in the target space R based on a graph-simultaneous localization and mapping (SLAM) algorithm using the layout constraint condition information for each group will be described as an example. However, in the present embodiment, since a graph-SLAM algorithm in related art is an already well-known algorithm, more detailed description thereof is omitted. That is, in the present embodiment, a difference between the graph-SLAM algorithm using the layout constraint condition information for each group and the graph-SLAM algorithm in the related art will be described. The graph-SLAM algorithm in the related art is described in detail in, for example, ““PROBABILISTIC ROBOTICS”, publisher: Mainichi Communications, authors: Sebastian Thrun, Wolfram Burgard, Dieter Fox, translator: Ryuichi Ueda”. The control system 1 may generate the map information based on SLAM of another type using the layout constraint condition information for each group. In addition, the control system 1 may generate the map information based on an algorithm other than the SLAM algorithm as an algorithm using the layout constraint condition information. Here, the algorithm may be a known algorithm or may be an algorithm to be developed in the future as long as it is an algorithm capable of generating map information. In the following, for convenience of description, graph-SLAM algorithm using the layout constraint condition information for each group will be referred to as layout constraint graph-SLAM.

Here, one feature of layout constraint graph-SLAM is introduced in comparison with a graph-SLAM algorithm different from layout constraint graph-SLAM (for example, the graph-SLAM algorithm in the related art).

To generate map information based on the graph-SLAM algorithm different from layout constraint graph-SLAM, the control system 1 needs to detect all the objects in the target space R by the detection unit 20. Accordingly, the control system 1 can estimate relative positions and postures of the object and the control target device 10 for all the objects in the target space R, and can perform addition (update) of each element of an information matrix in the graph-SLAM algorithm and addition (update) of each element of an information vector in the graph-SLAM algorithm.

On the other hand, when the map information is generated based on layout constraint graph-SLAM, the control system 1 can perform addition of each element of an information matrix in layout constraint graph-SLAM by detecting a part of objects in the target space R by the detection unit 20. That is, in this case, the control system 1 can perform the addition of each element of the information matrix in layout constraint graph-SLAM and addition of each element of an information vector in layout constraint graph-SLAM by detecting at least one of the object M1 or the object M2 and at least one of the object M3 or the object M4 among the four objects M1 to M4 by the detection unit 20. This is because, when the layout constraint condition information of the group G1 is used, relative positions and postures of the one of the object M1 and the object M2 and the control target device 10 can be estimated by estimating relative positions and postures of the other of the object M1 and the object M2 and the control target device 10, and when the layout constraint condition information of the group G2 is used, relative positions and postures of one of the object M3 and the object M4 and the control target device 10 can be estimated by estimating relative positions and postures of the other of the object M3 and the object M4 and the control target device 10. Therefore, when the control system 1 generates the map information indicating the map in the target space R based on layout constraint graph-SLAM, the control system 1 can accurately generate the map information even when a part of the plurality of objects grouped into one group in the target space R is positioned at a position that cannot be detected by the detection unit 20 (for example, a position in an occlusion region in an optical camera).

Next, the configurations of the control target device 10, the detection unit 20, and the information processing device 30 included in the control system 1 will be described in detail.

The control target device 10 is controlled by the information processing device 30. The control target device 10 is, for example, a moving body such as a drone, a movable robot, or an automatic guided vehicle (AGV), and may be an immovable device controlled by the information processing device 30. In addition, for example, the control target device 10 may be a device that is carried by a person or an animal such as a dog (that is, may be a non-self-propelled device). In the following, a case as illustrated in FIG. 1 where the control target device 10 is a drone will be described as an example. If the control target device 10 is a robot, the control target device 10 may be a robot that can be moved by propellers, feet, wheels, caterpillars, or the like, a robot that can move through the movement of the housing thereof such as a snake-shaped robot, a movable robot of another type, an immovable robot, and another device, another member, or the like that is immovable and includes the detection unit 20 described later, and the detection unit 20. However, even if the control target device 10 is an immovable device, the control target device 10 is a device that can detect a movement amount when carried by a person. The movement amount may be detected by the detection unit 20 or may be performed by a sensor different from the detection unit 20. The control target device 10 may include the information processing device 30. In the following, a case where the control target device 10 does not include the information processing device 30 will be described as an example.

The detection unit 20 may be any device as long as it can detect the object in the target space R. In the following, a case where the detection unit 20 is an imaging device (for example, a camera) including a charge coupled device (CCD), a complementary metal oxide semiconductor (CMOS), or the like as an imaging element that converts collected light into an electrical signal will be described as an example. That is, the detection unit 20 in the example detects the object in the target space R by imaging. The detection unit 20 images a capturable range according to control from the information processing device 30. The detection unit 20 outputs a captured image to the information processing device 30. The detection unit 20 may be another device such as light detection and ranging, laser imaging detection and ranging (LIDER) or time of flight (ToF) as long as it is a device that can detect the object. However, in this case, the detection unit 20 needs to identify each object by some method. As such method, a known method may be used, or a method to be developed in the future may be used.

Here, in the following, a case as illustrated in FIG. 1 where each of the objects M1 to M4 imaged by the detection unit 20 (that is, detected by the detection unit 20) is provided with a marker will be described as an example.

More specifically, the object M1 is provided with a marker MKR1 including a first marker on which identification information for identifying the object M1 is encoded as first encoded information and a second marker on which information indicating relative positions and postures of the detection unit 20 that detects the object M1 and the object M1 is encoded as second encoded information. The marker MKR1 may be a known marker or may be a marker to be developed in the future.

The object M2 is provided with a marker MKR2 including a first marker on which identification information for identifying the object M2 is encoded as first encoded information and a second marker on which information indicating relative positions and postures of the detection unit 20 that detects the object M2 and the object M2 is encoded as second encoded information. The marker MKR2 may be a known marker or may be a marker to be developed in the future.

The object M3 is provided with a marker MKR3 including a first marker on which identification information for identifying the object M3 is encoded as first encoded information and a second marker on which information indicating relative positions and postures of the detection unit 20 that detects the object M3 and the object M3 is encoded as second encoded information. The marker MKR3 may be a known marker or may be a marker to be developed in the future.

The object M4 is provided with a marker MKR4 including a first marker on which identification information for identifying the object M4 is encoded as first encoded information and a second marker on which information indicating relative positions and postures of the detection unit 20 that detects the object M4 and the object M4 is encoded as second encoded information. The marker MKR4 may be a known marker or may be a marker to be developed in the future.

In the following, for convenience of description, the markers MKR1 to MKR4 will be collectively referred to as a marker MKR unless necessary to be distinguished.

As described above, the detection unit 20 is provided in the control target device 10 in the example. Therefore, the range capturable by the detection unit 20 changes as the control target device 10 moves. That is, the detection unit 20 can image in a range according to a position and a posture of the control target device 10. Instead of being provided in the control target device 10, the detection unit 20 may be provided in the target space R so as to be capable of imaging at least a part of the target space R.

For example, the detection unit 20 captures a still image. The detection unit 20 may capture a video. In this case, the captured image described in the present embodiment can be replaced by each frame constituting the video captured by the detection unit 20.

The information processing device 30 is, for example, a multifunctional mobile phone terminal (smartphone). The information processing device 30 may be another information processing device such as a tablet personal computer (PC), a notebook PC, a personal digital assistant (PDA), a mobile phone terminal, a desktop PC, or a workstation instead of the multifunctional mobile phone terminal.

The information processing device 30 controls the control target device 10. For example, the information processing device 30 moves the control target device 10 along a predetermined trajectory based on a program stored in advance. In addition, for example, the information processing device 30 moves the control target device 10 according to a received operation.

The information processing device 30 controls the detection unit 20 while moving the control target device 10 along the predetermined trajectory, and causes the detection unit 20 to capture images in the range capturable by the detection unit 20 each time a predetermined sampling period elapses. The information processing device 30 acquires the image captured by the detection unit 20 from the detection unit 20. Here, time information indicating a time at which the image is captured is associated with each image captured by the detection unit 20. Based on a plurality of images captured by the detection unit 20 while the control target device 10 is moving along the predetermined trajectory and the layout constraint condition information for each group stored in advance, the information processing device 30 performs the addition of each element of the information matrix in layout constraint graph-SLAM and the addition of each element of the information vector in layout constraint graph-SLAM. Accordingly, the information processing device 30 optimizes an evaluation function in layout constraint graph-SLAM, and estimates the positions and the postures in a world coordinate system of the four objects in the target space R. The information processing device 30 can generate the map information indicating the map in the target space R based on an estimation result of the positions and the postures in the world coordinate system of the four objects in the target space R. A method for generating the map information in layout constraint graph-SLAM may be the same as a method for generating the map information in the graph-SLAM algorithm in the related art, or may be a method to be developed in the future. In this manner, the information processing device 30 generates the map information indicating the map in the target space R based on layout constraint graph-SLAM. Accordingly, even when the arrangement of the four objects in the target space R is changed from the initial arrangement, the information processing device 30 can accurately generate the map information indicating the map in the target space R. As a result, for example, the information processing device 30 can cause the control target device 10 to perform highly accurate work. Here, the world coordinate system is a three-dimensional orthogonal coordinate system for indicating the position and the posture in the real target space R, and for example, is a three-dimensional orthogonal coordinate system associated with the target space R.

Here, a new element that is not added in an information matrix in the graph-SLAM algorithm different from layout constraint graph-SLAM is added in the information matrix in layout constraint graph-SLAM. In layout constraint graph-SLAM, an element between the objects in each group in the target space R is added as a new element. Specifically, in the information matrix in layout constraint graph-SLAM, a value indicating a strength for constraining the arrangement of the object M1 and the object M2 based on the constraint condition for constraining so as not to change the arrangement of the object M1 and the object M2 and a value indicating a strength for constraining the arrangement of the object M3 and the object M4 based on the constraint condition for constraining so as not to change the arrangement of the object M3 and the object M4 are added as an element between the objects of each group in the target space R. Here, the value indicating the strength for constraining the arrangement of the object M1 and the object M2 based on the constraint condition for constraining so as not to change the arrangement of the object M1 and the object M2 is a reciprocal of an error value indicated by the information included in the layout constraint condition information of the group G1. That is, the value indicating the strength for constraining the arrangement of the object M1 and the object M2 based on the constraint condition for constraining so as not to change the arrangement of the object M1 and the object M2 becomes smaller as the error value becomes larger, and becomes larger as the error value becomes smaller. When the value indicating the strength for constraining the arrangement of the object M1 and the object M2 based on the constraint condition for constraining so as not to change the arrangement of the object M1 and the object M2 becomes larger, the relative positions and postures of the object M1 and the object M2 are less likely to change in the generation of the map information in layout constraint graph-SLAM. In addition, the value indicating the strength for constraining the arrangement of the object M3 and the object M4 based on the constraint condition for constraining so as not to change the arrangement of the object M3 and the object M4 is a reciprocal of an error value indicated by the information included in the layout constraint condition information of the group G2. That is, the value indicating the strength for constraining the arrangement of the object M3 and the object M4 based on the constraint condition for constraining so as not to change the arrangement of the object M3 and the object M4 becomes smaller as the error value becomes larger, and becomes larger as the error value becomes smaller. When the value indicating the strength for constraining the arrangement of the object M3 and the object M4 based on the constraint condition for constraining so as not to change the arrangement of the object M3 and the object M4 becomes larger, the relative positions and postures of the object M3 and the object M4 are less likely to change in the generation of the map information in layout constraint graph-SLAM.

On the other hand, the addition of each element of the information vector in layout constraint graph-SLAM is the same as addition of each element of an information vector in graph-SLAM algorithm in the related art. Therefore, detailed description for the addition of each element of the information vector in the layout constraint graph-SLAM will be omitted.

In the following, for convenience of description, relative positions and postures of a certain object and the control target device 10 will be referred to as object-device relative position and posture of the object. In addition, in the following, for convenience of description, relative positions and postures of two objects are referred to as inter-object relative position and posture of the two objects.

### Hardware Configuration of Information Processing Device

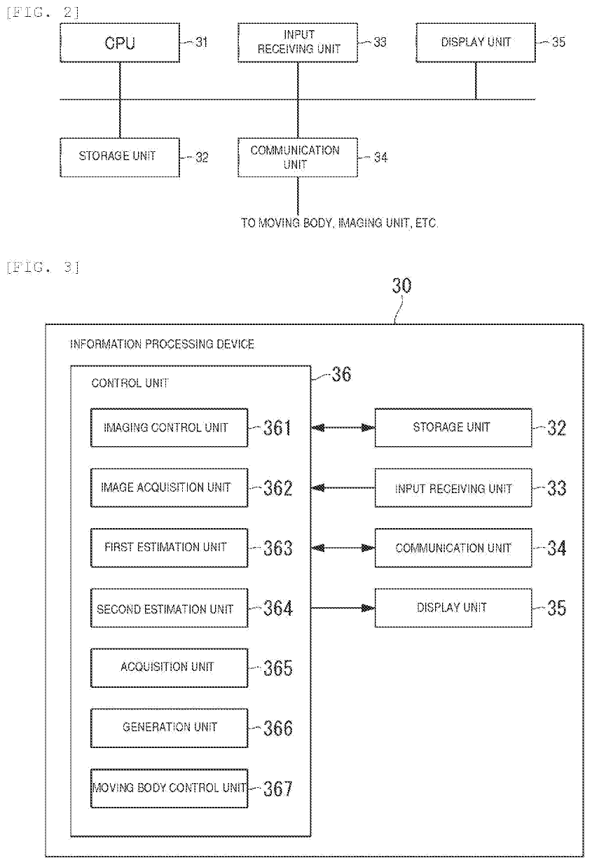

Hereinafter, a hardware configuration of the information processing device 30 will be described with reference to FIG. 2. FIG. 2 is a diagram illustrating an example of the hardware configuration of the information processing device 30.

The information processing device 30 includes, for example, a central processing unit (CPU) 31, a storage unit 32, an input receiving unit 33, a communication unit 34, and a display unit 35. These components are communicably connected to each other via a bus. In addition, the information processing device 30 communicates with the control target device 10 and the detection unit 20 via the communication unit 34.

The CPU 31 is, for example, a processor that controls the entire information processing device 30. The CPU 31 may be another processor such as a field programmable gate array (FPGA). The CPU 31 executes various programs stored in the storage unit 32.

The storage unit 32 includes, for example, a hard disk drive (HDD), a solid state drive (SSD), an electrically erasable programmable read-only memory (EEPROM), a read-only memory (ROM), or a random access memory (RAM). The storage unit 32 may be an external storage device connected to a digital input and output port such as a universal serial bus (USB) instead of being built in the information processing device 30. The storage unit 32 stores various kinds of information, various images, various programs, and the like processed by the information processing device 30. For example, the storage unit 32 stores the layout constraint condition information for each group described above.

The input receiving unit 33 is an input device such as a keyboard, a mouse, or a touch pad. The input receiving unit 33 may be a touch panel integrated with the display unit 35.

The communication unit 34 includes, for example, an antenna, a digital input and output port such as a USB, an Ethernet (registered trademark) port, or the like.

The display unit 35 is a display device including, for example, a liquid crystal display panel or an organic electro luminescence (EL) display panel.

### Functional Configuration of Information Processing Device

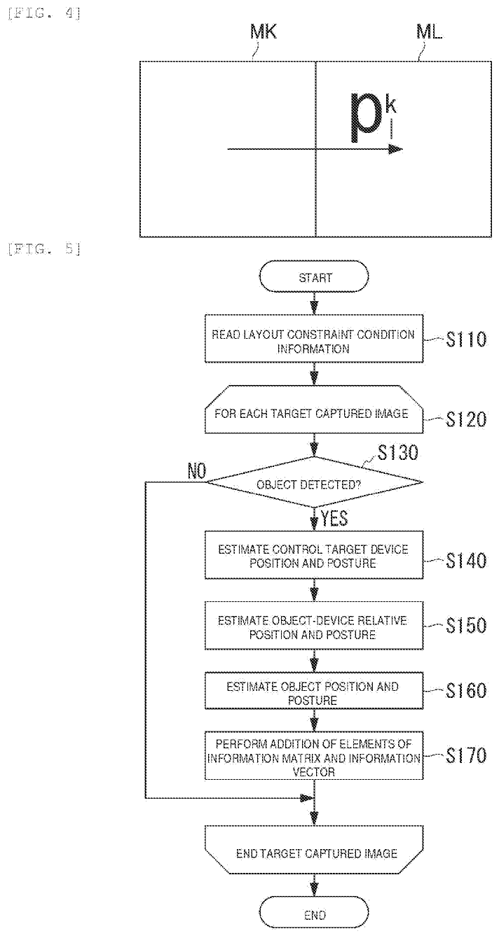

Hereinafter, a functional configuration of the information processing device 30 will be described with reference to FIG. 3. FIG. 3 is a diagram illustrating an example of the functional configuration of the information processing device 30.

The information processing device 30 includes the storage unit 32, the input receiving unit 33, the communication unit 34, the display unit 35, and a control unit 36.

The control unit 36 controls the entire information processing device 30. The control unit 36 includes, for example, an imaging control unit 361, an image acquisition unit 362, a first estimation unit 363, a second estimation unit 364, an acquisition unit 365, a generation unit 366, and a moving body control unit 367. These functional units included in the control unit 36 are implemented by, for example, the CPU 31 executing various programs stored in the storage unit 32. In addition, a part or all of the functional units may be hardware functional units such as a large scale integration (LSI) and an application specific integrated circuit (ASIC). Further, a part or all of the imaging control unit 361, the image acquisition unit 362, the first estimation unit 363, the second estimation unit 364, the acquisition unit 365, the generation unit 366, and the moving body control unit 367 may be integrally configured. A part or all of the imaging control unit 361, the image acquisition unit 362, the first estimation unit 363, the second estimation unit 364, the acquisition unit 365, the generation unit 366, and the moving body control unit 367 each may be divided into two or more functional units.

The imaging control unit 361 causes the detection unit 20 to capture images in the range capturable by the detection unit 20.

The image acquisition unit 362 acquires the image captured by the detection unit 20 from the detection unit 20.

The first estimation unit 363 estimates the position and the posture of the control target device 10 in the world coordinate system each time the detection unit 20 images. In the following, for convenience of description, the position and the posture of the control target device 10 in the world coordinate system will be referred to as control target device position and posture.

The second estimation unit 364 estimates the object-device relative position and posture of each of one or more objects captured in the captured image among the four objects in the target space R based on the captured image acquired by the image acquisition unit 362

The acquisition unit 365 acquires, from the second estimation unit 364, object-device relative position and posture information indicating each of the one or more pieces of object-device relative position and posture estimated by the second estimation unit 364.

The generation unit 366 performs the addition of each element of the information matrix and the addition of each element of the information vector based on the layout constraint condition information stored in advance in the storage unit 32, the object-device relative position and posture information acquired by the acquisition unit 365, and the control target device position and posture estimated by the first estimation unit 363. The generation unit 366 optimizes the evaluation function based on the information matrix and the information vector after the addition of each element is performed, and estimates the positions and the postures of the four objects in the target space R in the world coordinate system. The generation unit 366 generates the map information indicating the map in the target space R based on an estimation result of the positions and the postures of the four objects in the target space R in the world coordinate system.

The moving body control unit 367 controls the control target device 10. For example, the moving body control unit 367 moves the control target device 10 along the predetermined trajectory based on an operation program stored in advance in the storage unit 32. In addition, for example, the moving body control unit 367 moves the control target device 10 according to a received operation.

### Method for Adding Each Element of Information Matrix in Layout Constraint Graph-SLAM

Hereinafter, a method for adding each element of the information matrix in the layout constraint graph-SLAM will be described. However, in the following, a method for adding elements related to the objects in each group in the target space R to the information matrix will be described, and a method for adding elements other than the elements is the same as the method for adding in the graph-SLAM algorithm in the related art.

In the following, for convenience of description, each of the four objects in the target space R is identified by a value of a variable k. The value of k is any one of 1 to 4. If k=1, k denotes the object M1. If k=2, k denotes the object M2. If k=3, k denotes the object M3. If k=4, k denotes the object M4. In the following, for convenience of description, one object among the four objects in the target space R whose relative position and posture with respect to another object identified based on the value of k are constrained based on the layout constraint condition information is identified by a value of a variable l. The value of l is any value from 1 to 4 other than the value of k. In the following, as an example, the time is represented by t. However, in the embodiment, a reference time is represented by t=0, and elapse of time from t=0 is represented by adding an integer to t. That is, in the embodiment, the time t is discretized. In the embodiment, x\hat{ }y means that x is accompanied by y as a superscript, that is, x^{y}. In addition, in the embodiment, x_y means that x is accompanied by y as a subscript, that is, x_{y}. Further, in the embodiment, x\hat{ }y_z means that x is accompanied by y as a superscript and x is accompanied by z as a subscript. Here, each of x, y, and z may be any letter, or may be a series of two or more letters enclosed in braces. For example, xyz\hat{ }{jkl} means xyz^{jkl}. Also, for example, xyz_{jkl} means xyzⱼₖₗ. In addition, for example, x\hat{ }{y_z} means that x is accompanied by y_z as a superscript. Further, for example, x_{y_z} means that x is accompanied by y_z as a subscript. In the following, a case where the position in the world coordinate system is represented by coordinates on an xy plane in the world coordinate system will be described as an example. Further, in the following, a case where the posture in the world coordinate system is represented by an azimuth angle in the world coordinate system will be described as an example. The position in the world coordinate system may be represented by three-dimensional coordinates in the world coordinate system. The posture in the world coordinate system may be represented by an Euler angle in the world coordinate system.

For example, consider a case where an object identified by a certain value of k is captured in the image captured by the detection unit 20 at a certain time t, that is, a case where the object is detected by the detection unit 20. In this case, a position and a posture of the object in the world coordinate system can be calculated based on the following Formulae (1) and (2) by using a position and a posture of the control target device 10 in the world coordinate system at the time t and object-device relative position and posture of the object at the time t. In the following, for convenience of description, a position and a posture of a certain object in the world coordinate system will be referred to as object position and posture of the object.

$$\begin{matrix}[ Formula 1 ] & \\ {m}_{k} = {r}_{t} + ( \begin{matrix}cos ( {θ}_{rt} ) & - sin ( {θ}_{rt} ) & 0 \\ sin ( {θ}_{rt} ) & cos ( {θ}_{rt} ) & 0 \\ 0 & 0 & 1\end{matrix} ) {Z}_{{k}_{t}} & ( 1 )\end{matrix}$$

$$\begin{matrix}[ Formula 2 ] & \\ {r}_{t} = ( \begin{matrix}{x}_{rt} \\ {y}_{rt} \\ {θ}_{rt}\end{matrix} ) & ( 2 )\end{matrix}$$

$$\begin{matrix}[ Formula 3 ] & \\ {z}_{{k}_{t}} = ( \begin{matrix}{x}_{{m}_{k}}^{{r}_{t}} \\ {y}_{{m}_{k}}^{{r}_{t}} \\ {θ}_{{m}_{k}}^{{r}_{t}}\end{matrix} ) & ( 3 )\end{matrix}$$

Here, m_k is a vector having three values indicating the object position and posture of the object identified by k as elements. r_t is a vector indicating control target device position and posture at the time t. r_t is represented by Formula (2). x_rt is an x coordinate indicating the position of the control target device in the world coordinate system at the time t. y_rt is a y coordinate indicating the position of the control target device 10 in the world coordinate system at the time t. θ_rt is an azimuth angle indicating the posture of the control target device 10 in the world coordinate system at the time t. Z_k_t is a vector representing an observed value of the object. More specifically, Z_k_t is a vector representing the object-device relative position and posture of the object estimated based on the image captured by the detection unit 20 at the time t. Z_k_t is explicitly represented by Formula (3). x\hat{ }{r_t}_{m_k}, which is a first element on a right side of Formula (3), is an x coordinate indicating relative positions of the object and the control target device 10 at the time t. In other words, x\hat{ }{r_t}_{m_k} is an x coordinate indicating a relative position of “m_k indicating the object position and posture of the object identified by k” viewed from “r_t indicating the control target device position and posture at the time t”. y\hat{ }{r_t}_{m_k}, which is a second element on the right side of Formula (2), is a y coordinate indicating relative positions of the object and the control target device 10 at the time t. In other words, y\hat{ }{r_t}_{m_k} is a y coordinate indicating a relative position of “m_k indicating the object position and posture of the object identified by k” viewed from “r_t indicating the control target device position and posture at the time t”. In addition, θ\hat{ }{r_t}_{m_k}, which is a third element on the right side of Formula (2), is an azimuth angle indicating relative postures of the object and the control target device 10 at the time t. In other words, θ\hat{ }{r_t}_{m_k} is an azimuth angle indicating a relative posture of “m_k indicating the object position and posture of the object identified by k” viewed from “r_t indicating the control target device position and posture at the time t”.

On the other hand, inter-object relative position and posture of the object identified by the value of k and the object identified by the value of l is specified by the layout constraint condition information for each group stored in advance in the storage unit 32. The layout constraint condition information including inter-object relative position and posture information can be represented by the following Formulae (4) and (5).

$$\begin{matrix}[ Formula 4 ] & \\ {p}_{l}^{k} = ( \begin{matrix}{σ}_{l}^{k} \\ {m}_{l}^{k}\end{matrix} ) & ( 4 )\end{matrix}$$

$$\begin{matrix}[ Formula 5 ] & \\ {m}_{l}^{k} = ( \begin{matrix}{x}_{{m}_{l}}^{{m}_{k}} \\ {y}_{{m}_{l}}^{{m}_{k}} \\ {θ}_{{m}_{l}}^{{m}_{k}}\end{matrix} ) & ( 5 )\end{matrix}$$

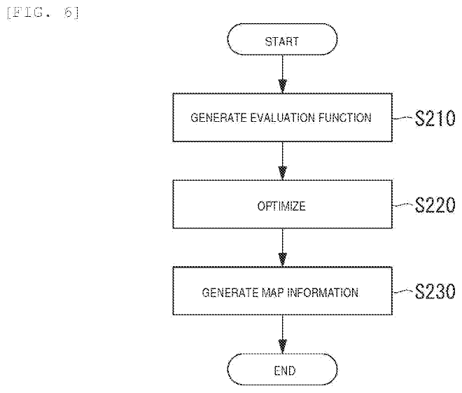

Here, p\hat{ }k_l, which is on a left side of Formula (4), is a vector indicating layout constraint condition information including information indicating the inter-object relative position and posture of the object identified by the value of k and the object identified by the value of l as a constraint condition for constraining so as not to change the arrangement of the two objects. More specifically, p\hat{ }k_l is a vector indicating layout constraint condition information including information indicating the relative position and posture of the object identified by the value of k with respect to the position and the posture of the object identified by the value of l as the constraint condition. FIG. 4 is a conceptual diagram of the vector illustrated in Formula (4). An object MK illustrated in FIG. 4 is an example of the object identified by the value of k. An object ML illustrated in FIG. 4 is an example of the object identified by the value of l. An arrow illustrated in FIG. 4 indicates an example of the vector. That is, the vector is represented as a vector indicating a position of the object ML from a position of the object MK. In FIG. 4, the position of the object MK is represented by a centroid position of the object MK as an example. In addition, in FIG. 4, the position of the object MK is represented by the centroid position of the object MK as an example. The vector actually has, as elements, values indicating a strength for constraining an arrangement of the object MK and the object ML based on a constraint condition for constraining so as not to change the arrangement of the object MK and the object ML, and is only conceptually indicated by the arrow in FIG. 4. σ\hat{ }k_l, which is a first element on a right side of Formula (4), indicates an error value allowed for the relative position and posture of the object identified by the value of k with respect to the position and the posture of the object identified by the value of l (the value may be a single value, a vector, or a matrix). m\hat{ }k_l, which is a second element on the right side of Formula (4), is a vector indicating the relative position and posture of the object identified by the value of k with respect to the position and the posture of the object identified by the value of l. That is, the second element is a vector indicating the inter-object relative position and posture of the two objects. The second element on the right side of Formula (4) is represented by Formula (5). x\hat{ }{m_k}_{m_l}, which is a first element on a right side of Formula (5), is an x coordinate indicating the relative position of the object identified by the value of k with respect to the position of the object identified by the value of l. y\hat{ }{m_k}_{m_l}, which is a second element on the right side of Formula (5), is a y coordinate indicating the relative position of the object identified by the value of k with respect to the position of the object identified by the value of l. θ\hat{ }{m_k}_{m_l}, which is a third element on the right side of Formula (5), is an azimuth angle indicating the relative posture of the object identified by the value of k with respect to the posture of the object identified by the value of l.

When the layout constraint condition information represented as in Formula (4) and Formula (5) is used, even when the object identified by the value of l is not detected by the detection unit 20 at the time t, the position and the posture of the object in the world coordinate system can be calculated based on the following Formula (6).

$$\begin{matrix}[ Formula 6 ] & \\ {m}_{l} = {m}_{k} + ( \begin{matrix}cos ( {θ}_{rt} ) & - sin ( {θ}_{rt} ) & 0 \\ sin ( {θ}_{rt} ) & cos ( {θ}_{rt} ) & 0 \\ 0 & 0 & 1\end{matrix} ) {m}_{k}^{l} & ( 6 )\end{matrix}$$

Here, when the object position and posture of the object identified by the value of k, the layout constraint condition information represented by Formula (4), and the object position and posture of the object identified by the value of l can be calculated, elements related to the two objects can be added to an information matrix Ω and an information vector ξ as in the following Formula (7).

$$\begin{matrix}[ Formula 7 ] & \\ Ω = ( \begin{matrix}⋱ & & & & \\ & {( {σ}_{l}^{k} )}^{- 1} & … & {( {σ}_{l}^{k} )}^{- 1} & \\ & ⋮ & ⋱ & ⋮ & \\ & {( {σ}_{l}^{k} )}^{- 1} & … & {( {σ}_{l}^{k} )}^{- 1} & \\ & & & & ⋱\end{matrix} ) , ξ = {Ω}_{l , k} ( \begin{matrix}⋮ \\ {m}_{k} \\ ⋮ \\ {k}_{l} \\ ⋮\end{matrix} ) & ( 7 )\end{matrix}$$

The elements explicitly illustrated in the information matrix Ω in Formula (7) are elements related to m_l and m_k in the information matrix Ω, that is, elements related to the object identified by the value of k and the object identified by the value of l. The elements are reciprocals of a first element of the vector representing the layout constraint condition information. That is, the elements are values indicating a strength for constraining the arrangement of the object identified by the value of k and the object identified by the value of l based on the constraint condition for constraining so as not to change the arrangement of two objects. The elements explicitly illustrated in the information vector ξ in Formula (7) are elements related to m_l and m_k in the information vector ξ, and are m_l and m_k themselves.

In this manner, the information processing device 30 can perform addition of each element of the information matrix Ω and addition of each element of the information vector ξ based on Formulae (1) to (7) and the image captured by the detection unit 20 at the time t. The information processing device 30 performs the addition of such elements based on the image captured by the detection unit 20 at each time. Accordingly, the information processing device 30 can generate the information matrix Ω and the information vector ξ in layout constraint graph-SLAM.

Here, the object position and posture of the object identified by the value of l may be calculated based on Formulae (1) and (2) together with the position and the posture of the object identified by the value of k in the world coordinate system. In the following, for convenience of description, the position and the posture calculated based on Formulae (1) and (2) among the object position and posture of the object identified by the value of l will be referred to as first estimated position and posture. In the following, for convenience of description, the position and the posture calculated based on Formula (6) among the object position and posture of the object identified by the value of l will be referred to as second estimated position and posture. A difference vector between a vector representing the first estimated position and posture and a vector representing the second estimated position and posture can be used to calculate an amount representing a magnitude of deviation between the first estimated position posture and the second estimated position and posture. Such an amount is an amount that can be calculated as a distance between the first estimated position and posture and the second estimated position and posture, and is, for example, an inner product in an Euclidean space, a Mahalanobis distance in a multivariate space, and Kullback Leibler (KL) information in a probability space. In the following, a case where the amount representing the magnitude of the deviation between the first estimated position and posture and the second estimated position and posture is an inner product of the difference vector will be described as an example. In this case, when the inner product exceeds a predetermined first threshold value, it is considered that the arrangement of the object identified by the value of l and the object identified by the value of k is changed from an initial arrangement. When the arrangement of the two objects is changed from the initial arrangement, a connection of the elements related to m_l and m_k in the information matrix Ω should be deleted. Deletion of the connection of the elements means replacing the elements with 0. The following Formulae (8) and (9) represent the inner product of the difference vector.

$$\begin{matrix}[ Formula 8 ] & \\ {md}_{l}^{k} = ( {mf}_{l}^{k} - {m}_{l} ) \cdot ( {mf}_{l}^{k} - {m}_{l} ) & ( 8 )\end{matrix}$$

$$\begin{matrix}[ Formula 9 ] & \\ {mf}_{l}^{k} = {m}_{k} + ( \begin{matrix}cos ( {θ}_{rt} ) & - sin ( {θ}_{rt} ) & 0 \\ sin ( {θ}_{rt} ) & cos ( {θ}_{rt} ) & 0 \\ 0 & 0 & 1\end{matrix} ) {p}_{l}^{k} & ( 9 )\end{matrix}$$

A left side of Formula (8) indicates the inner product described above. A first term in each of two sets of parentheses on a right side of Formula (8) is the vector representing the second estimated position and posture. The first term is calculated based on Formula (9). A second term of each of the two sets of parentheses on the right side of Formula (8), that is, m_l is the vector representing the first estimated position and posture.

Here, the first threshold value described above is, for example, an estimation error of the second estimated position and posture. The estimation error may be estimated by any method. The first threshold value may be another value instead of the estimation error. The inner product described above is repeatedly calculated in iterative processing related to the addition of each element of the information matrix Ω and the information vector ξ in layout constraint graph-SLAM. Therefore, when the number of times the inner product exceeds the first threshold value exceeds a predetermined second threshold value, it is desirable that the elements related to m_l and m_k in the information matrix Ω are replaced with 0. The second threshold value is a number between 0.0 and 1.0. When the second threshold value is 1.0, even when layout change between the objects is performed in layout constraint graph-SLAM, the layout change between the objects is not reflected in a result. On the other hand, as the second threshold value approaches 0.0, in layout constraint graph-SLAM, when the layout change between the objects is performed, the layout change between the objects is easily reflected in the result. In the following, for convenience of description, processing of replacing the elements related to the two objects with 0 in this manner will be referred to as layout cancellation processing.

### Processing of Generating Information Matrix and Information Vector by Information Processing Device

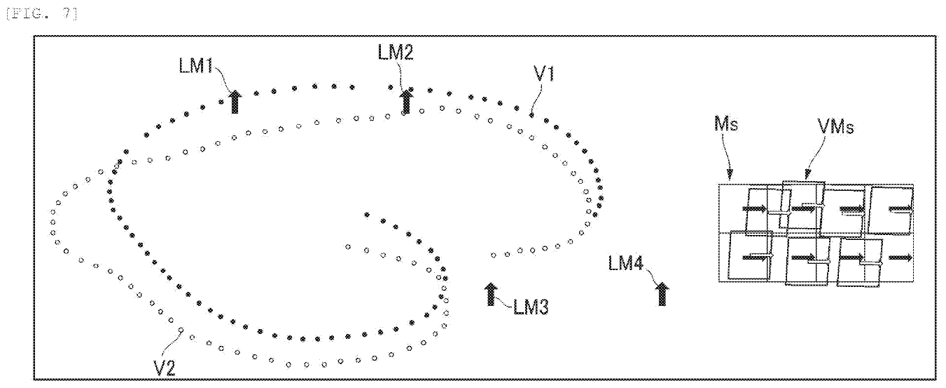

Hereinafter, processing of generating the information matrix Ω and the information vector ξ by the information processing device 30 will be described with reference to FIG. 5. FIG. 5 is a diagram illustrating an example of a flow of the processing of generating the information matrix Ω and the information vector ξ by the information processing device 30. In the following, a case where the information processing device 30 acquires, from the detection unit 20, the plurality of images captured by the detection unit 20 during a period in which the control target device 10 is moving along the predetermined trajectory at a timing before processing of step S110 illustrated in FIG. 5 is performed will be described as an example. In the following, a case where the information processing device 30 receives an operation of starting the processing in advance at the timing will be described as an example.

The second estimation unit 364 reads the layout constraint condition information for each group stored in advance in the storage unit 32 from the storage unit 32 (step S110).

Next, the control unit 36 selects, from the plurality of captured images acquired in advance from the detection unit 20, the captured images one by one in an ascending order of a captured time as target captured images, and repeatedly performs processing in steps S130 to S170 for each of the selected target captured images (step S120).

After the target captured images are selected in step S120, the second estimation unit 364 determines whether one of the four objects in the target space R is captured in the selected target captured images (step S130). That is, in step S130, the second estimation unit 364 determines whether one of the four objects in the target space R is detected based on the selected target captured images. In FIG. 5, the processing in step S130 is indicated by “object detected?”.

When it is determined that none of the four objects in the target space R is captured in the selected target captured images (step S130—NO), the second estimation unit 364 proceeds to step S120 and selects the next target captured image. When there is no captured image that can be selected as the next target captured image in step S120, the control unit 36 ends the iterative processing in step S120 to step S170 and ends the processing of a flowchart illustrated in FIG. 5.

On the other hand, when the second estimation unit 364 determines that at least one of the four objects in the target space R is captured in the selected target captured images (step S130—YES), the first estimation unit 363 specifies a time at which the target captured image is captured based on time information associated with the target captured image. The first estimation unit 363 estimates control target device position and posture at each specified time based on a predetermined initial value and history of a speed of the control target device 10 that is moving on the predetermined trajectory (step S140). Here, the predetermined initial value is an initial value of each of the three elements of the vector representing the position and the posture of the control target device 10 in the world coordinate system. These three initial values may be any values.

Next, the second estimation unit 364 estimates object-device relative position and posture of one or more objects captured in the target captured images among the four objects in the target space R based on the target captured images (step S150). Here, for example, when a certain object among the four objects is captured in the target captured images, the second estimation unit 364 reads the first encoded information and the second encoded information from the marker MKR of the object. Accordingly, the second estimation unit 364 can identify which of the four objects the object is, and can estimate object-device relative position and posture information of the object at the time specified in step S140. In step 150, the second estimation unit 364 performs such estimation for each of the one or more objects captured in the target captured images.

Next, the acquisition unit 365 acquires an estimation result estimated by the second estimation unit 364 in step S150. The generation unit 366 estimates the object position and posture of each of the one or more objects captured in the target captured images among the four objects in the target space R and one or more objects constituting groups with each of the one or more objects based on the estimation result, the layout constraint condition information read from the storage unit 32 in step S110, and an estimation result estimated by the first estimation unit 363 in step S140 (step S160). Since the estimation method in step S160 is described in <Method for Adding Each Element of Information Matrix in Layout Constraint Graph-SLAM>, detailed description thereof will be omitted here. In addition, in step S160, the generation unit may calculate the inner product of the difference vector between the vector representing the first estimated position and posture and the vector representing the second estimated position and posture for each of the one or more objects captured in the target captured images, and determine whether the calculated inner product exceeds the first threshold value. In this case, for example, when the object M1 is captured in the target captured images, the generation unit 366 calculates the inner product of the difference vector between the vector representing the first estimated position and posture for the object M1 and the vector representing the second estimated position and posture for the object M1 in step S160, and determines whether the calculated inner product exceeds the first threshold value. In the iterative processing in step S120 to step S170, when the number of times it is determined up to now that the inner product calculated for the object M1 exceeds the first threshold value exceeds the second threshold value, the generation unit 366 performs layout cancellation processing of replacing the elements related to the object M1 and the object M2 with 0.

Next, the generation unit 366 performs the addition of each element of the information matrix Ω and the addition of each element of the information vector ξ based on an estimation result in step S160 and the layout constraint condition information read in step S110 (step S170). Since the addition method in step S170 is described in <Method for Adding Each Element of Information Matrix in Layout Constraint Graph-SLAM>, detailed description thereof will be omitted here.

After the processing in step S170 is performed, the control unit 36 proceeds to step S120 and selects the next target captured image. When there is no captured image that can be selected as the next target captured image in step S120, the control unit 36 ends the iterative processing in step S120 to step S170 and ends the processing of a flowchart illustrated in FIG. 5.

The acquisition unit 365 may acquire the estimation result estimated by the first estimation unit 363 in step S140 and the estimation result estimated in step S150 from another device. In this case, the generation unit 366 performs the processing in step S160 and the processing in step S170 based on the estimation results acquired by the acquisition unit 365. Accordingly, the information processing device 30 can generate the information matrix Ω and the information vector ξ in layout constraint graph-SLAM.

### Processing of Generating Map Information by Information Processing Device

Hereinafter, processing of generating the map information by the information processing device 30 will be described with reference to FIG. 6. FIG. 6 is a diagram illustrating an example of a flow of the processing of generating the map information by the information processing device 30. In the following, a case where the information processing device 30 generates the information matrix Ω and the information vector ξ by the processing of the flowchart illustrated in FIG. 5 at a timing before processing in step S210 illustrated in FIG. 6 is performed will be described as an example. In the following, a case where the information processing device 30 receives an operation of starting the processing in advance at the timing will be described as an example.

The generation unit 366 generates the evaluation function in layout constraint graph-SLAM based on the information matrix Ω and the information vector ξ that are generated in advance (step S210). A method for generating the evaluation function may be a method in the graph-SLAM algorithm in the related art or a method to be developed in the future.

Next, the generation unit 366 performs optimization processing based on the evaluation function generated in step S210 (step S220). An optimization method used in the optimization processing in step S220 may be a known method or may be a method to be developed in the future. Accordingly, the generation unit 366 can estimate the positions and the postures of the four objects in the target space R in the world coordinate system.

Next, the generation unit 366 generates the map information indicating the map in the target space R based on an estimation result in step S220 (step S230), and ends the processing of a flowchart illustrated in FIG. 6.

As described above, the information processing device 30 estimates the control target device position and posture based on the predetermined initial value, acquires the object-device relative position and posture information of at least one of the four objects in the target space R, and generates the map information indicating the map in the target space R based on the layout constraint condition information stored in the storage unit 32, the acquired object-device relative position and posture information of the at least one object, and the estimated control target device position and posture. Accordingly, even when the arrangement of the four objects in the target space R is changed from the initial arrangement, the information processing device 30 can accurately generate the map information indicating the map in the target space R.

### Performance Test Result of Information Processing Device by Simulator

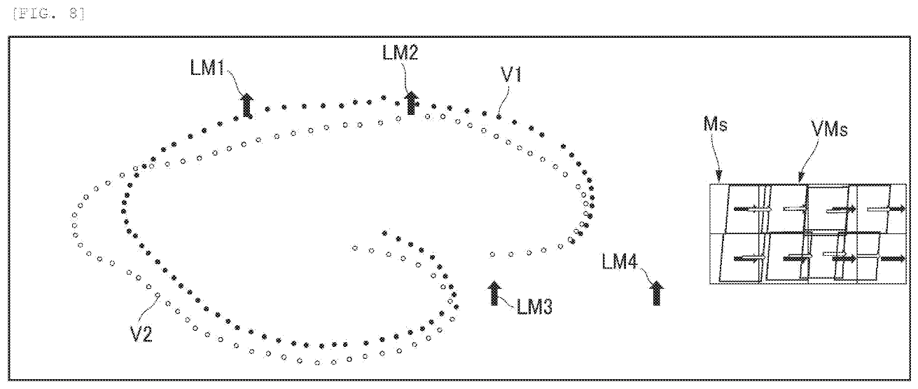

Hereinafter, a performance test result of the information processing device 30 by a simulator will be described with reference to the drawings. FIG. 7 is a diagram illustrating an example of the map information generated by the information processing device 30. However, in generation of the map information illustrated in FIG. 7, the information processing device 30 generates map information indicating a map in the space in which the control target device 10 is positioned based on the graph-SLAM algorithm in the related art that does not use the layout constraint condition information. The space of the map indicated by the map information illustrated in FIG. 7 is a space in which eight objects whose relative positions and postures are held by the layout constraint are arranged. In addition, in the space, in order to improve convergence of iterative processing in the graph-SLAM algorithm, four landmarks LM1 to LM4 fixed such that positions and postures thereof are not moved in the world coordinate system are arranged. As a result, accuracy of the entire map is improved as compared with a method in the related art. However, these four landmarks LM1 to LM4 do not substantially affect accuracy of a relative positional relationship between the objects in the map information illustrated in FIG. 7. Therefore, a part or all of the four landmarks LM1 to LM4 may not be arranged in the space. In FIG. 7, positions where the eight objects arranged in the space are actually positioned are indicated by eight dotted-line squares Ms. In addition, in FIG. 7, actual postures of the eight objects are indicated by arrows attached to the eight dotted-line squares Ms. Further, A path V1 indicated by a dotted line in FIG. 7 indicates a moving path of the control target device 10 estimated by the control target device 10. On the other hand, a path V2 indicated by a dotted line in FIG. 7 indicates a moving path of the actual control target device 10. That is, in the example illustrated in FIG. 7, the information processing device 30 causes the control target device 10 to move along the path V2 as a predetermined trajectory while causing the detection unit 20 to image. Each of eight squares VMs indicated by solid lines in FIG. 7 indicates the position of each of the eight objects estimated by the control target device 10. Each of arrows attached to the eight squares VMs indicated by the solid lines in FIG. 7 indicates the posture of each of the eight objects estimated by the control target device 10. As illustrated FIG. 7, it can be seen that when the graph-SLAM algorithm in the related that does not use the layout constraint condition information is used, the information processing device 30 cannot accurately estimate the positions and the postures of the eight objects. This is apparent from a low matching degree between the eight squares Ms and the eight squares VMs and a low matching degree between the arrows attached to these squares.

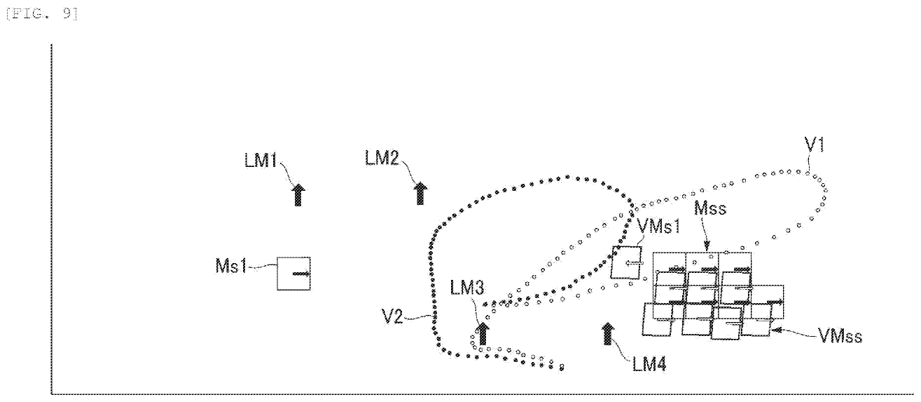

On the other hand, FIG. 8 is a diagram illustrating another example of the map information generated by the information processing device 30. However, in generation of the map information illustrated in FIG. 8, the information processing device 30 generates map information indicating a map in the same space as the space illustrated in FIG. 7 based on layout constraint graph-SLAM. As illustrated in FIG. 8, it can be seen when layout constraint graph-SLAM is used, the information processing device 30 can accurately estimate the positions and the postures of the eight objects as compared with a result in FIG. 7, which uses the graph-SLAM algorithm in the related art that does not use the layout constraint condition information. This is apparent from a fact that the matching degree between the eight squares Ms and the eight squares VMs in FIG. 8 is higher than the matching degree between the eight squares Ms and the eight squares VMs in FIG. 7. This is also apparent from a fact that the matching degree between the arrows attached to the eight squares Ms and the eight squares VMs in FIG. 8 is higher than the matching degree between the arrows attached to the eight squares Ms and the eight squares VMs in FIG. 7. That is, even when the arrangement of the plurality of objects in the space in which the control target device 10 is positioned is changed from the initial arrangement, the information processing device 30 can accurately generate the map information indicating the map in the space. The layout constraint graph-SLAM used to obtain a result illustrated in FIG. 8 may perform the layout cancellation processing described above or may not perform the layout cancellation processing.

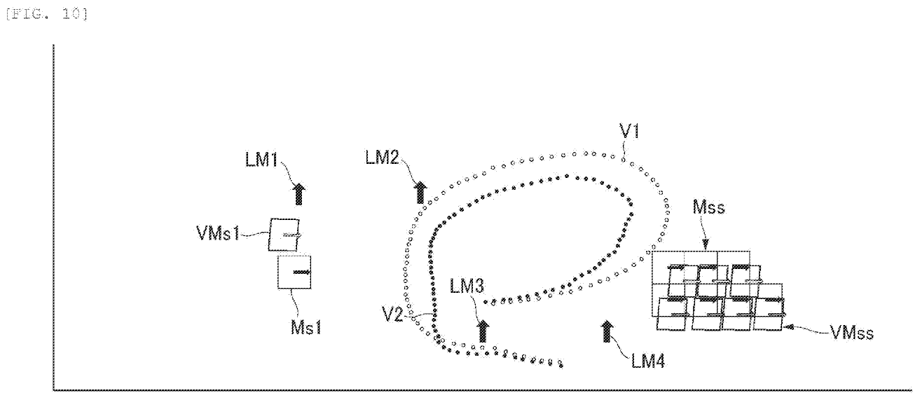

Next, FIG. 9 is a diagram illustrating still another example of the map information generated by the information processing device 30. However, in generation of the map information illustrated in FIG. 9, the information processing device 30 generates map information indicating a map in the space in which the control target device 10 is positioned based on layout constraint graph-SLAM. A space of the map indicated by the map information illustrated in FIG. 9 is the same space as the space illustrated in FIG. 7 except for a part. In the space illustrated in FIG. 9, one of the eight objects whose relative positions and postures are held by the layout constraint is moved to a position away from the remaining seven objects. Such movement of the one object is a difference between the space illustrated in FIG. 7 and the space illustrated in FIG. 9. In FIG. 9, positions in which the seven objects are actually positioned are indicated by seven dotted-line squares Mss. In FIG. 9, actual postures of the seven objects are indicated by arrows attached to the seven dotted-line squares Mss. In FIG. 9, a position in which the one object that is released from the layout constraint is actually positioned is indicated by a dotted-line square Ms1. In FIG. 9, an actual posture of the one object is indicated by an arrow attached to the dotted-line square Ms1. Each of seven squares VMss indicated by solid lines in FIG. 9 indicates the position of each of the seven objects estimated by the control target device 10. Each of arrows attached to the seven squares VMss indicated by the solid lines in FIG. 9 indicates the posture of each of the seven objects estimated by the control target device 10. A square VMs1 indicated by a solid line in FIG. 9 indicates the position of the one object estimated by the control target device 10. An arrow attached to the square VMs1 indicated by the solid line in FIG. 9 indicates the posture of the one object estimated by the control target device 10. Here, FIG. 9 is a result of generating the map information indicating the map in the space based on layout constraint graph-SLAM in which the layout cancellation processing is not performed by the information processing device 30. As illustrated in FIG. 9, in this case, it can be seen that the information processing device 30 cannot accurately estimate the positions and the postures of the eight objects. This is apparent from a low matching degree between the seven squares Mss and the seven squares VMss, and is further apparent from a fact that the squares Ms1 and the squares VMs1 are separated.

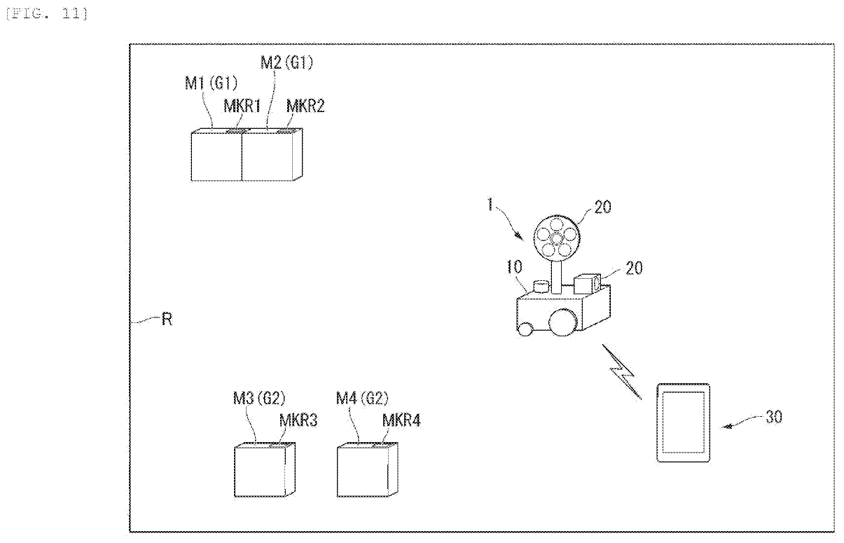

On the other hand, FIG. 10 is a diagram illustrating yet another example of the map information generated by the information processing device 30. However, in generation of the map information illustrated in FIG. 10, the information processing device 30 generates map information indicating a map in the same space as the space illustrated in FIG. 9 based on layout constraint graph-SLAM in which the layout cancellation processing is performed. As illustrated in FIG. 10, it can be seen that when layout constraint graph-SLAM in which the layout cancellation processing is performed is used, the information processing device 30 can accurately estimate the positions and the postures of the seven objects and the position and the posture of the one object as compared with the result in FIG. 9. That is, the information processing device 30 can more reliably and accurately generate the map information indicating the map in the space by using layout constraint graph-SLAM in which the layout cancellation processing is performed even when the arrangement of the plurality of objects in the space in which the control target device 10 is positioned is changed from the initial arrangement.

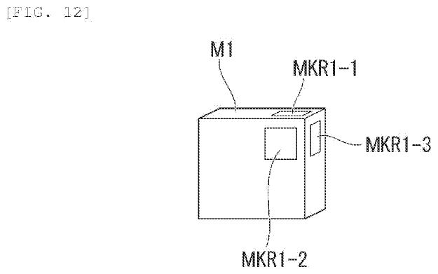

As described above, the control target device 10 described above may be a movable robot including wheels instead of the drone. FIG. 11 is a diagram illustrating another example of the configuration of the control system 1 according to the embodiment. In this case as well, the information processing device 30 can estimate the positions and the postures of the four objects in the target space R in the world coordinate system based on layout constraint graph-SLAM, and generate the map information indicating the map in the target space R.

A plurality of markers may be provided on at least one of the objects M1 to M4 described above. FIG. 12 is a diagram illustrating an example of the object M1 provided with three markers. The object M1 illustrated in FIG. 12 is provided with three markers including a marker MKR1-1, a marker MKR1-2, and a marker MKR1-3. Accordingly, the markers provided on the object M1 are easily captured in the images captured by the detection unit 20. If the information processing device 30 can identify each of the three markers, the information processing device 30 can more accurately detect the posture of the object M1 based on the captured images in which the object M1 is captured. It is desirable to adopt a method using a Huecode in which a QR code (registered trademark) and an AR code are combined as a method of using these three markers as identifiable markers. Since the Huecode is already known, detailed description thereof will be omitted. The Huecode is described in detail in, for example, patent literature of JP2020-169115A.

The position and the posture described above may be the position alone. In this case, the posture described above is not used for various processing, and various processing and the like are executed using only the position. In this case, for example, the various information indicating the position and the posture is information indicating the position.

Alternatively, the position and the posture described above may be the posture alone. In this case, the position described above is not used for various processing, and various processing and the like are executed using only the posture. In this case, for example, the various information indicating the position and the posture is information indicating the posture.

As described above, an information processing device (in the examples described above, the information processing device 30) according to the embodiment is an information processing device for controlling a control target device to be controlled (in the examples described above, the control target device 10), and includes: a storage unit (in the examples described above, the storage unit 32) configured to store layout constraint condition information including information indicating relative positions and postures of a first object (in the examples described above, for example, the object M1) disposed in a space (in the examples described above, the target space R) in which the control target device is positioned and a second object (in the examples described above, for example, the object M2) different from the first object disposed in the space; and a control unit (in the examples described above, the control unit 36) configured to generate map information indicating a map in the space based on a position and a posture of the control target device, at least one of first object-device relative position and posture information indicating relative positions and postures of the first object and the control target device or second object-device relative position and posture information indicating relative positions and postures of the second object and the control target device, and the layout constraint condition information stored in the storage unit. Accordingly, even when an arrangement of a plurality of objects in the space in which the control target device is positioned is changed from an initial arrangement, the information processing device can accurately generate the map information indicating the map in the space.

In the information processing device, the control unit may include: a first estimation unit (in the examples described above, the first estimation unit 363) configured to estimate the position and the posture of the control target device based on a predetermined initial value; an acquisition unit (in the examples described above, the acquisition unit 365) configured to acquire at least one of the first object-device relative position and posture information or the second object-device relative position and posture information as object-device relative position and posture information; and a generation unit (in the examples described above, the generation unit 366) configured to generate the map information indicating the map in the space based on the layout constraint condition information stored in the storage unit, the object-device relative position and posture information acquired by the acquisition unit, and the position and the posture of the control target device estimated by the first estimation unit.

In the information processing device, the control unit may further include a second estimation unit (in the examples described above, the second estimation unit 364) configured to estimate at least one of the relative positions and postures of the first object and the control target device or the relative positions and postures of the second object and the control target device based on an output from a detection unit (in the examples described above, the detection unit 20) that detects at least one of the first object or the second object, and the acquisition unit may be configured to acquire, from the second estimation unit, information indicating at least one of the relative positions and postures of the first object and the control target device or the relative positions and postures of the second object and the control target device as the object-device relative position and posture information.

In the information processing device, the generation unit may be configured to generate the map information based on graph-SLAM.

In the information processing device, the generation unit may be configured to generate an information matrix and an information vector in graph-SLAM based on the object-device relative position and posture information acquired by the acquisition unit, the layout constraint condition information stored in the storage unit, and the position and the posture of the control target device estimated by the first estimation unit, and generate the map information by optimizing an evaluation function based on the generated information matrix and information vector.

In the information processing device, the generation unit may be configured to estimate positions and postures of the first object and the second object based on the object-device relative position and posture information acquired by the acquisition unit, the layout constraint condition information stored in the storage unit, and the position and the posture of the control target device estimated by the first estimation unit, and generate the information matrix and the information vector based on the estimated positions and postures of the first object and the second object.

In the information processing device, the generation unit may be configured to: if both the first object-device relative position and posture information and the second object-device relative position and posture information are acquired by the acquisition unit as the object-device relative position and posture information, estimate the position and the posture of the first object as first estimated position and posture and estimate the position and the posture of the second object as second estimated position and posture based on the position and the posture of the control target device estimated by the first estimation unit, the object-device relative position and posture information acquired by the acquisition unit, and the layout constraint condition information stored in the storage unit; estimate the position and the posture of the first object as third estimated position and posture and estimate the position and the posture of the second object as fourth estimated position and posture based on the position and the posture of the control target device estimated by the first estimation unit and the object-device relative position and posture information acquired by the acquisition unit; calculate a difference between a vector indicating the first estimated position and posture and a vector indicating the third estimated position and posture as a first difference and calculate a difference between a vector indicating the second estimated position and posture and a vector indicating the fourth estimated position and posture as a second difference; and delete connections between elements of the information matrix that are determined according to the layout constraint condition information, based on the first difference, an estimation error of the position and the posture of the first object, the second difference, and an estimation error of the position and the posture of the second object.

In the information processing device, the control target device may be a moving body capable of changing the position and the posture of the control target device.

As described above, an information processing device (in the examples described above, the information processing device 30) according to the embodiment is an information processing device for controlling a control target device to be controlled (in the examples described above, the control target device 10), and includes: a storage unit (in the examples described above, the storage unit 32) configured to store layout constraint condition information including information indicating relative positions of a first object (in the examples described above, for example, the object M1) disposed in a space (in the examples described above, the target space R) in which the control target device is positioned and a second object (in the examples described above, for example, the object M2) different from the first object disposed in the space; and a control unit (in the examples described above, the control unit 36) configured to generate map information indicating a map in the space based on a position of the control target device, at least one of first object-device relative position information indicating relative positions of the first object and the control target device or second object-device relative position information indicating relative positions of the second object and the control target device, and the layout constraint condition information stored in the storage unit. Accordingly, even when an arrangement of a plurality of objects in the space in which the control target device is positioned is changed from an initial arrangement, the information processing device can accurately generate the map information indicating the map in the space.

In the information processing device, the control unit may include: a first estimation unit (in the examples described above, the first estimation unit 363) configured to estimate the position of the control target device based on a predetermined initial value; an acquisition unit (in the examples described above, the acquisition unit 365) configured to acquire at least one of the first object-device relative position information or the second object-device relative position information as object-device relative position information; and a generation unit (in the examples described above, the generation unit 366) configured to generate the map information indicating the map in the space based on the layout constraint condition information stored in the storage unit, the object-device relative position information acquired by the acquisition unit, and the position of the control target device estimated by the first estimation unit.

In the information processing device, the control unit may further include a second estimation unit (in the examples described above, the second estimation unit 364) configured to estimate at least one of the relative positions of the first object and the control target device or the relative positions of the second object and the control target device based on an output from a detection unit (in the examples described above, the detection unit 20) that detects at least one of the first object or the second object, and the acquisition unit may be configured to acquire, from the second estimation unit, information indicating at least one of the relative positions of the first object and the control target device or the relative positions of the second object and the control target device as the object-device relative position information.

In the information processing device, the generation unit may be configured to generate the map information based on graph-SLAM.

In the information processing device, the generation unit may be configured to generate an information matrix and an information vector in graph-SLAM based on the object-device relative position information acquired by the acquisition unit, the layout constraint condition information stored in the storage unit, and the position of the control target device estimated by the first estimation unit, and generate the map information by optimizing an evaluation function based on the generated information matrix and information vector.

In the information processing device, the generation unit may be configured to estimate positions of the first object and the second object based on the object-device relative position information acquired by the acquisition unit, the layout constraint condition information stored in the storage unit, and the position of the control target device estimated by the first estimation unit, and generate the information matrix and the information vector based on the estimated positions of the first object and the second object.

In the information processing device, the generation unit may be configured to: if both the first object-device relative position information and the second object-device relative position information are acquired by the acquisition unit as the object-device relative position information, estimate the position of the first object as a first estimated position and estimate the position of the second object as a second estimated position based on the position of the control target device estimated by the first estimation unit, the object-device relative position information acquired by the acquisition unit, and the layout constraint condition information stored in the storage unit; estimate the position of the first object as a third estimated position and estimate the position of the second object as a fourth estimated position based on the position of the control target device estimated by the first estimation unit and the object-device relative position information acquired by the acquisition unit; calculate a difference between a vector indicating the first estimated position and a vector indicating the third estimated position as a first difference and calculate a difference between a vector indicating the second estimated position and a vector indicating the fourth estimated position as a second difference; and delete connections between elements of the information matrix that are determined according to the layout constraint condition information, based on the first difference, an estimation error of the position of the first object, the second difference, and an estimation error of the position of the second object.

In the information processing device, the control target device may be a moving body configured to change at least one of the position or the posture of the control target device.

As described above, an information processing device (in the examples described above, the information processing device 30) according to the embodiment is an information processing device for controlling a control target device to be controlled (in the examples described above, the control target device 10), and includes: a storage unit (in the examples described above, the storage unit 32) configured to store layout constraint condition information including information indicating relative postures of a first object (in the examples described above, for example, the object M1) disposed in a space (in the examples described above, the target space R) in which the control target device is positioned and a second object (in the examples described above, for example, the object M2) different from the first object disposed in the space; and a control unit (in the examples described above, the control unit 36) configured to generate map information indicating a map in the space based on a posture of the control target device, at least one of first object-device relative posture information indicating relative postures of the first object and the control target device or second object-device relative posture information indicating relative postures of the second object and the control target device, and the layout constraint condition information stored in the storage unit. Accordingly, even when an arrangement of a plurality of objects in the space in which the control target device is positioned is changed from an initial arrangement, the information processing device can accurately generate the map information indicating the map in the space.

In the information processing device, the control unit may include: a first estimation unit (in the examples described above, the first estimation unit 363) configured to estimate the posture of the control target device based on a predetermined initial value; an acquisition unit (in the examples described above, the acquisition unit 365) configured to acquire at least one of the first object-device relative posture information or the second object-device relative posture information as object-device relative posture information; and a generation unit (in the examples described above, the generation unit 366) configured to generate the map information indicating the map in the space based on the layout constraint condition information stored in the storage unit, the object-device relative posture information acquired by the acquisition unit, and the posture of the control target device estimated by the first estimation unit.

In the information processing device, the control unit may further include a second estimation unit (in the examples described above, the second estimation unit 364) configured to estimate at least one of the relative postures of the first object and the control target device or the relative postures of the second object and the control target device based on an output from a detection unit (in the examples described above, the detection unit 20) that detects at least one of the first object or the second object, and the acquisition unit may be configured to acquire, from the second estimation unit, information indicating at least one of the relative postures of the first object and the control target device or the relative postures of the second object and the control target device as the object-device relative posture information.

In the information processing device, the generation unit may be configured to generate the map information based on graph-SLAM.

In the information processing device, the generation unit may be configured to generate an information matrix and an information vector in graph-SLAM based on the object-device relative posture information acquired by the acquisition unit, the layout constraint condition information stored in the storage unit, and the posture of the control target device estimated by the first estimation unit, and generate the map information by optimizing an evaluation function based on the generated information matrix and information vector.

In the information processing device, the generation unit may be configured to estimate postures of the first object and the second object based on the object-device relative posture information acquired by the acquisition unit, the layout constraint condition information stored in the storage unit, and the posture of the control target device estimated by the first estimation unit, and generate the information matrix and the information vector based on the estimated postures of the first object and the second object.

In the information processing device, the generation unit may be configured to: if both the first object-device relative posture information and the second object-device relative posture information are acquired by the acquisition unit as the object-device relative posture information, estimate the posture of the first object as a first estimated posture and estimate the posture of the second object as a second estimated posture based on the posture of the control target device estimated by the first estimation unit, the object-device relative posture information acquired by the acquisition unit, and the layout constraint condition information stored in the storage unit; estimate the posture of the first object as a third estimated posture and estimate the posture of the second object as a fourth estimated posture based on the posture of the control target device estimated by the first estimation unit and the object-device relative posture information acquired by the acquisition unit; calculate a difference between a vector indicating the first estimated posture and a vector indicating the third estimated posture as a first difference and calculate a difference between a vector indicating the second estimated posture and a vector indicating the fourth estimated posture as a second difference; and delete connections between elements of the information matrix that are determined according to the layout constraint condition information, based on the first difference, an estimation error of the posture of the first object, the second difference, and an estimation error of the posture of the second object.

In the information processing device, the control target device may be a moving body configured to change at least one of the position or the posture of the control target device.

As described above, the embodiment of the invention has been described in detail with reference to the drawings, but the specific configuration is not limited to the embodiment, and changes, substitutions, deletions, and the like may be made without departing from the gist of the invention.

A program for implementing functions of any component in the device described above (for example, the control target device 10, the detection unit 20, the information processing device 30, or the like) may be recorded in a computer-readable recording medium, and the program may be read and executed by a computer system. The “computer system” here includes an operating system (OS) and hardware such as a peripheral device. In addition, the “computer-readable recording medium” refers to a storage device such as a portable medium such as a flexible disk, a magneto-optical disk, a read only memory (ROM), and a compact disk (CD)-ROM, or a hard disk built in the computer system. Further, the “computer-readable recording medium” also includes one that holds a program for a certain period of time, such as a volatile memory ((random access memory) RAM) in a computer system serving as a server or a client when the program is transmitted via a network such as the Internet or a communication line such as a telephone line.

The program may be transmitted from a computer system in which the program is stored in a storage device or the like to another computer system via a transmission medium or a transmission wave in the transmission medium. Here, the “transmission medium” that transmits the program refers to a medium having a function of transmitting information, such as a network (communication network) such as the Internet or a communication line (communication wire) such as a telephone line.

In addition, the program may be a program for implementing a part of the functions described above. Further, the program may be a so-called differential file (differential program) that can implement the functions described above in combination with a program already recorded in the computer system.

### REFERENCE SIGNS LIST

1: control system
10: control target device
20: detection unit
30: information processing device
31: CPU
32: storage unit
33: input receiving unit
34: communication unit
35: display unit
36: control unit
361: imaging control unit
362: image acquisition unit
363: first estimation unit
364: second estimation unit
365: acquisition unit
366: generation unit
367: moving body control unit
MKR, MKR1, MKR2, MKR3, MKR4: markers
R: target space

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. An information processing device for controlling a control target device to be controlled, the information processing device comprising:
a storage unit configured to store a plurality of objects arranged in a space in which the control target device is positioned, one or more groups including a part of the plurality of objects and grouped according to a use, and layout constraint condition information for constraining so as not to change relative arrangements and/or postures of the objects constituting the group; and
a control unit configured to generate map information in the space based on relative positions and/or postures of a part of the objects and the control target device in the space and the layout constraint condition information stored in the storage unit.

16. The information processing device according to claim 15, wherein
the layout constraint condition information includes error values of relative positions and/or postures allowed between the objects constituting the group.

17. The information processing device according to claim 16, wherein
the layout constraint condition information is represented by a vector and includes a first element of an error value of relative positions and relative postures of two objects constituting the group and a second element of the relative positions and the relative postures of the two objects, and
the second element includes an x coordinate and a y coordinate indicating the relative positions of the two objects and an azimuth angle indicating the relative positions of the objects.

18. The information processing device according to claim 17, wherein
the control unit is configured to calculate, from a vector of object position and posture of relative positions and/or relative postures of the control target device and at least one of the objects constituting the group, which is acquired by the control target device at a first time and calculated from an image of the object and a vector of the layout constraint condition information, a vector of a position and/or posture of another object constituting the group that is not acquired by the control target device.

19. The information processing device according to claim 18, wherein
the control unit is configured to generate, from the vector of the object position and posture and the vector of the layout constraint condition information, an information matrix and an information vector that are related to the objects constituting the group by adding elements based on the vector of the object position and posture that is acquired and calculated at each time by the control target device.

20. The information processing device according to claim 18, wherein
the control unit is configured to obtain a difference vector between a first estimated position and posture vector, which is a position and a posture calculated from the vector of the object position and posture, and a second estimated position and posture vector, which is a position and/or posture calculated from the vector of the position and/or posture of the another object constituting the group that is not acquired by the control target device, and delete the second element of the two objects constituting the group when an inner product of the difference vector exceeds a predetermined threshold value.

21. An information processing method comprising:
a reading step of reading, from a storage unit that stores a plurality of objects arranged in a space in which a control target device is positioned, one or more groups including a part of the plurality of objects and grouped according to a use, and layout constraint condition information for constraining so as not to change relative arrangements and/or postures of the objects constituting the group, the layout constraint condition information; and
a generating step of generating map information in the space based on relative positions and/or postures of a part of the objects and the control target device in the space and the layout constraint condition information stored in the storage unit.

22. A program for causing a computer to execute:
a reading step of reading, from a storage unit that stores a plurality of objects arranged in a space in which a control target device is positioned, one or more groups including a part of the plurality of objects and grouped according to a use, and layout constraint condition information for constraining so as not to change relative arrangements and/or postures of the objects constituting the group, the layout constraint condition information; and
a generating step of generating map information in the space based on relative positions and/or postures of a part of the objects and the control target device in the space and the layout constraint condition information stored in the storage unit.
